(19) United States
(12) Patent Application Publication
(10) Pub. No.: US 2014/0085432 A1
(43) Pub. Date: Mar. 27, 2014

(54) METHOD TO STORE AND RETRIEVE CROSSTALK PROFILES OF 3D STEREOSCOPIC DISPLAYS

(71) Applicant: 3M INNOVATIVE PROPERTIES COMPANY, St. Paul, MN (US)

(72) Inventors: Shuguang Wu, Austin, TX (US); Glenn E. Casner, Woodbury, MN (US)

(73) Assignee: 3M INNOVATIVE PROPERTIES COMPANY, St. Paul, MN (US)

(21) Appl. No.: 13/628,476

(22) Filed: Sep. 27, 2012

(51) Int. Cl. H04N 13/04

(52) U.S. Cl. 348/51; 348/E13.059

(57) ABSTRACT

A method of reducing crosstalk for a 3D stereoscopic display using locally stored crosstalk profiles. The method generates a crosstalk profile for a stereoscopic display and stores the crosstalk profile in a memory, such as the EDID or DID, locally associated with the display. The crosstalk profile includes information for reducing crosstalk in the display based at least in part upon operational characteristics of the display. The method retrieves the crosstalk profile and applies the information in the crosstalk profile to stereoscopic content displayed on the display in order to reduce crosstalk in the displayed content. Using a locally stored crosstalk profile provides for crosstalk reduction tailored to a specific display.

### BACKGROUND

3D stereoscopic displays are a type of display that provides the user with two or more images (e.g., a left and a right eye view) in order to achieve a three-dimensional effect. Different technologies exist for these types of 3D displays, such as passive glasses (anaglyph or polarizer), active shutter glasses, and autostereoscopic (spatial multiplexing or temporal multiplexing). For example, one type of autostereoscopic display is a time-sequential 3D display that produces a full resolution stereoscopic display by optically forming distinct viewing regions for left and right eyes.

Crosstalk is the result of incomplete isolation between imagery intended for the left and right eyes. It is a factor that affects the stereoscopic display experience since the crosstalk is apparent to a viewer. Different types of stereoscopic displays have different crosstalk characteristics. Even within the same technology, crosstalk can vary among models, for example nine inch versus fifteen inch displays. Although algorithms exist to reduce crosstalk, those algorithms are general in nature and not tied to a specific display. Accordingly, a need exists for crosstalk reduction algorithms that take into consideration the specific operational characteristics or parameters of the associated display.

### SUMMARY

A method of reducing crosstalk for a stereoscopic display using locally stored crosstalk profiles, consistent with the present invention, includes generating a crosstalk profile for a stereoscopic display and storing the crosstalk profile in a memory locally associated with the display. The crosstalk profile includes information for reducing crosstalk in the display based at least in part upon the operational characteristics of the display. The method also includes applying the information in the crosstalk profile to stereoscopic content displayed on the stereoscopic display in order to reduce crosstalk in the displayed content.

A system for reducing crosstalk for a stereoscopic display using locally stored crosstalk profiles, consistent with the present invention, includes a stereoscopic display and a processor electronically connected to the display. The processor is configured to generate a crosstalk profile for the display and store the crosstalk profile in a memory locally associated with the display. The crosstalk profile includes information for reducing crosstalk in the display based at least in part upon the operational characteristics of the display. The processor is also configured to apply the information in the crosstalk profile to stereoscopic content displayed on the stereoscopic display in order to reduce crosstalk in the displayed content.

### BRIEF DESCRIPTION OF THE DRAWINGS

The accompanying drawings are incorporated in and constitute a part of this specification and, together with the description, explain the advantages and principles of the invention. In the drawings,

FIG. 1 is a block diagram of a system having locally stored crosstalk profiles for a 3D stereoscopic display; and

FIG. 2 is a flow chart of a method to store and retrieve crosstalk profiles for a 3D stereoscopic display.

### DETAILED DESCRIPTION

Embodiments of the present invention include a method to store display-dependent 3D crosstalk profiles for specific types of 3D stereoscopic displays. The crosstalk profiles are tailored to the operational characteristics or physical parameters of specific displays, which enhances the effectiveness of crosstalk reduction in content displayed on them. Multiple profiles can be stored to specify different characteristics of the same display, for example an active shutter glass stereoscopic display versus a directional backlight unit autostereoscopic display. Parameters such as optimal viewing distance can also be stored and communicated to the end users as part of the crosstalk profile. Examples of 3D stereoscopic displays are disclosed in U.S. Pat. Nos. 8,179,362 and 7,800,708, both of which are incorporated herein by reference as if fully set forth.

The crosstalk profiles can be saved as part of the EDID (Extended Display Identification Data) or DID (Display ID) of the 3D displays, which can be parsed by 3D sources, such as a graphics processing unit (GPU). EDID is a data structure defined by VESA (Video Electronics Standards Association). VESA has developed the DID standard as a replacement of EDID. The method described herein can use the EDID or DID to implement the display specific crosstalk profiles. Alternatively, such profiles can be locally stored in other locations associated with the corresponding displays.

EDID is supplied as part of the display to describe its capabilities to a host with graphics sources (e.g., PC graphics card, set-top-box, or BLU-RAY player). It is typically stored in the displays in non-volatile memory such as EEPROM (Electrically Erasable Programmable Read-Only Memory). In systems where the host and display are connected through display interfaces, the EDID is read by the host from the display through the E-DDC (Enhanced Display Data Channel). E-DDC is a serial communication protocol standardized by VESA and supported by all standard interfaces (e.g., Digital Visual Interface (DVI), Video Graphics Array (VGA), High-Definition Multimedia Interface (HDMI), Low Voltage Differential Signaling (LVDS), and DisplayPort).

All EDID include a 128 byte data structure (Base EDID), which includes manufacturer name, serial number, product type, supported timings, display size, chromaticity data, and other related data. Some versions of EDID can allow additional data to be stored in one or more (up to 255) Extension Blocks appended to the Base EDID. Each Extension Block is 128 Bytes in length. VESA assigned Extension Block Tag Numbers to numerically identify the types of the Extension Blocks. Table 1 reflects the current VESA assigned Extension Tag Numbers.

TABLE 1
Extension Tag Numbers

| Tag Numbers | Extension Block Description |
|---|---|
| 02h | CEA-EXT: CEA 861 Series Extension |
| 10h | VTB-EXT: Video Timing Block Extension |
| 40h | DI-EXT: Display Information Extension |
| 50h | LS-EXT: Localized String Extension |
| 60h | DPVL-EXT: Digital Packet Video Link Extension |
| F0h | Extension Block Map |
| FFh | Extensions defined by the display manufacturer |

Embodiments of the present invention store the 3D stereoscopic crosstalk profiles in one or more EDID Extension Blocks or other local storage associated with the display. The crosstalk profiles can be stored using a dedicated Extension Tag Number, if available, in the EDID. It is also feasible to store the crosstalk profiles using the Tag Number “FFh” which can be defined and populated by display manufacturers.

Illustrated below is an example of a data structure for the 3D crosstalk profile in an EDID extension block. The crosstalk profile is organized as a linear array of N pairs of left (C_{L}) and right (C_{R}) crosstalk:

[C_{L}(0),C_{R}(0)],[C_{L}(1),C_{R}(1)], . . . [C_{L}(N−1),C_{R}(N−1)]

N is the number of positions along the horizontal direction of the display where the left and right crosstalk are measured. Larger N results in higher precision but also more complicated measurement as well as processing. Therefore, the choice of N is at the discretion of the system and display designer. In the example provided below N is limited to 61 ((128−6)/2), however larger N is possible through a more sophisticated data structure.

In the processing stage, the crosstalk profile CP_{L}(x,y), CP_{R}(x,y) at a given pixel position (x,y) with screen resolution (H,V) is approximated as:

CP_{L}(x,y)=C_{L}(ROUND(x*N/H))

CP_{R}(x,y)=C_{R}(ROUND(x*N/H))

An example of one method to generate a crosstalk profile for a specific display involves using a conoscope and a displayed test pattern to measure actual left and right crosstalk at a number of horizontal (x) positions and vertical (y) positions on the display. Tables 2 and 3 illustrate a structure for the resulting measured crosstalk percentages (Cₗ(x,y), Cᵣ(x,y)), indicating an amount of crosstalk at each (x,y) position. At each horizontal position, an average crosstalk percentage (C_{L}(x), C_{R}(x)) can be generated based upon the number of vertical positions (n), and the average crosstalk percentages along the horizontal positions (N) can be used to compensate for crosstalk in displayed left and right images.

TABLE 2
Left Crosstalk

| | x1 | x2 | . . . | xN |
|---|---|---|---|---|
| y1 | Cₗ(x1,y1) | Cₗ(x2,y1) | | Cₗ(xN,y1) |
| y2 | Cₗ(x1,y2) | Cₗ(x2,y2) | | Cₗ(xN,y2) |
| . . . | . . . | . . . | | . . . |
| yn | Cₗ(x1,yn) | Cₗ(x2,yn) | . . . | Cₗ(xN,yn) |
| Average | C_{L}(x1 average) | C_{L}(x2 average) | . . . | C_{L}(xN average) |

TABLE 3
Right Crosstalk

| | x1 | x2 | . . . | xN |
|---|---|---|---|---|
| y1 | Cᵣ(x1,y1) | Cᵣ(x2,y1) | | Cᵣ(xN,y1) |
| y2 | Cᵣ(x1,y2) | Cᵣ(x2,y2) | | Cᵣ(xN,y2) |
| . . . | . . . | . . . | | . . . |
| yn | Cᵣ(x1,yn) | Cᵣ(x2,yn) | . . . | Cᵣ(xN,yn) |
| Average | C_{R}(x1 average) | C_{R}(x2 average) | . . . | C_{R}(xN average) |

To facilitate displays that can be used in different stereoscopic modes (e.g., anaglyph, shutter glasses or directional backlight autostereoscopic), it is possible to have multiple crosstalk profiles for the same display. Based on the viewing method detected by the system or through user selection, the application can select the applicable crosstalk profile for processing. Table 4 provides an example of a crosstalk profile extension block in EDID.

TABLE 4
Example of Crosstalk Profile Extension Block in EDID

| | | |
|---|---|---|
| Address/Offset | Value (HEX) | Function |

Base EDID

| | | |
|---|---|---|
| 00-07 | 00FFFFFFFFFFFF00 | EDID Header |
| . . . | . . . | . . . |
| 7E | 01 | Extension Flag |
| 7F | XX | Checksum |

3D Crosstalk Profile Extension Block

| | | |
|---|---|---|
| 80 | “3D”h | Extension Tag Code for crosstalk profile |
| | | block |
| 81 | 01 | 3D Extension block version #1 |
| 82 | 02 | 3D Technology: 00 - Anaglyph; 01 - Shutter |
| | | glass; 02 - Autostereoscopic; . . . |
| 83 | “D” | D = Optimum viewing distance in cm (hex); |
| | | Value = 00: N/A (e.g., for shutter glass); e.g., |
| | | 4Bh = 75 cm |
| 84 | “N” | N = Length of 3D crosstalk profile; e.g., 20h = |
| | | 32 Bytes |
| 85 | XX | C_{L}(0) |
| 86 | XX | C_{R}(0) |
| . . . | . . . | . . . |
| 85 + 2 * N | XX | C_{L}(N − 1) |
| 85 + 2 * N + 1 | XX | C_{R}(N − 1) |
| . . . | 00 | Patch |
| FF | XX | Checksum |

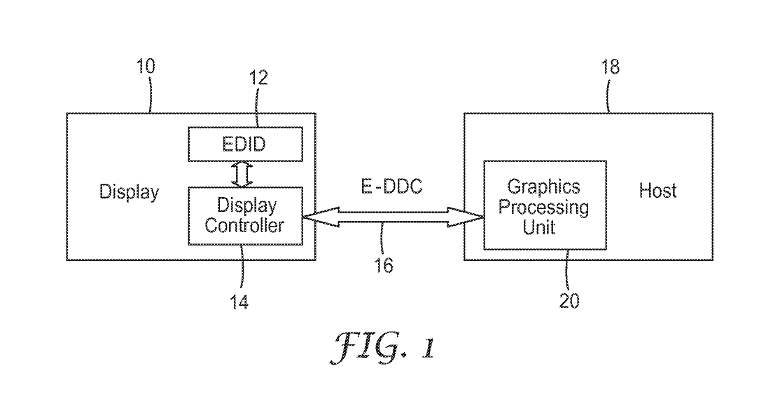

FIG. 1 is a block diagram of a system having locally stored crosstalk profiles for a 3D display. The system includes a 3D display 10 having an EDID 12 for storing a crosstalk profile and a display controller 14. An associated host 18 for display 10 has a GPU 20 and can communicate with display 10 via an E-DDC 16. Host 18 generates the left and right image data and applies information from the crosstalk profile in EDID 12 for display 10 in order to reduce or eliminate crosstalk in the displayed images.

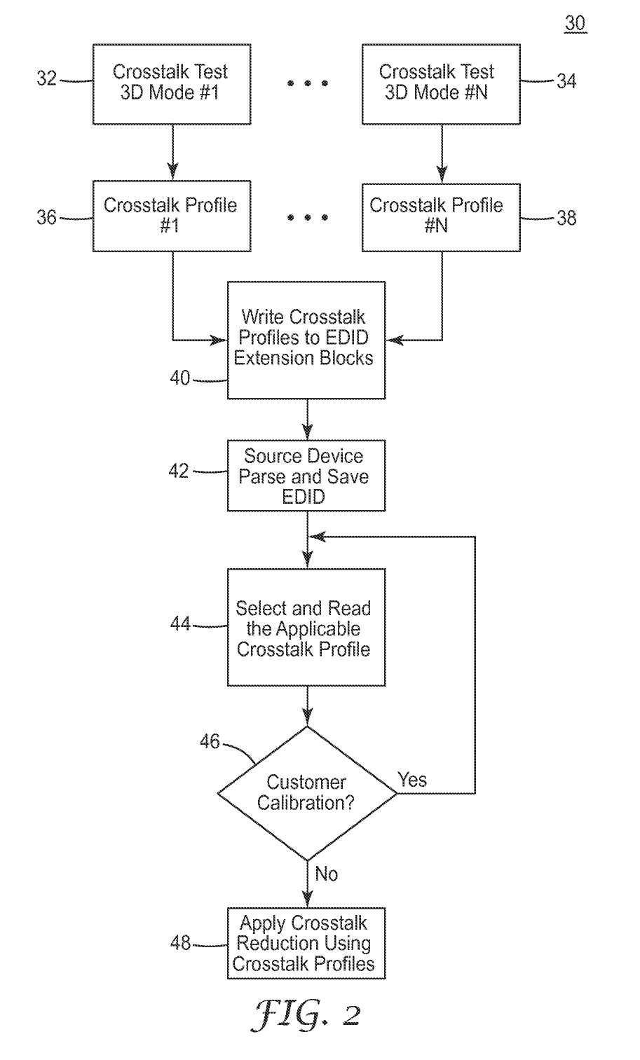

FIG. 2 is a flow chart of a method 30 for crosstalk reduction using locally stored crosstalk profiles, including characterization, record, storage, retrieving and real-time processing. It is possible for the end customers to generate new crosstalk profiles through display calibration in the field. Such profiles can be saved and retrieved in addition to the default crosstalk profiles from EDID. Method 30 can be implemented in, for example, software executed by a processor such as GPU 20 in host 18 for controlling display 10.

In method 30, crosstalk test modes for 3D modes 1, . . . N are performed (steps 32, 34). The 3D modes refer to the specific 3D displays, and the crosstalk tests are performed on the specific 3D displays to obtain crosstalk information for them based at least in part upon the operational characteristics or physical parameters of the displays. From the crosstalk test modes, crosstalk profiles 1, . . . N are generated for the corresponding displays (steps 36, 38). The crosstalk test mode can involve applying a crosstalk algorithm to change luminance values for the display pixels and then fine tuning the luminance values for the particular display. The test modes can also involve displaying a test image or pattern on the display having crosstalk and then eliminating or sufficiently reducing the displayed crosstalk by modifying the pixel luminance values. An example of a method to reduce perceived crosstalk in a stereoscopic display is described in U.S. Patent Application Publication No. 2009/0167639, which is incorporated herein by reference as fully set forth.

The crosstalk test modes can also involve creating new luminance values directly based upon the crosstalk test mode. The information in the crosstalk profiles includes the change in luminance values for the particular display. For example as described above, the profile can specify the coefficient values (luminance) of the pixels in order to change the color intensity of the displayed images to compensate for crosstalk. The coefficients can include values for the red, green, blue (RGB) subpixels for the pixels. The resulting crosstalk profiles are thus tailored to specific displays. The crosstalk profiles can also include other information to enhance a user's viewing experience, such as optimal viewing distance.

The crosstalk profiles are written to the EDID extension blocks for the corresponding displays (step 40), for example EDID 12 in display 10. In particular, the source devices, for example host 18, parse and locally save the EDID with the crosstalk profiles (step 42). In operation when displaying content, the 3D device selects and reads the applicable locally stored crosstalk profile (step 44), for example host 18 reads the crosstalk profile from EDID 12 for display 10. The 3D device determines if a customer has calibrated the 3D display (step 46). If the display has been calibrated, the system uses the calibration as the default crosstalk profile. If the display has not been calibrated, the system applies crosstalk reduction to the displayed content using the crosstalk profiles (step 48). For example, host 18 using the crosstalk profile for display 10 changes the luminance values for the stereoscopic content to be displayed on display 10.

1. A method of reducing crosstalk for a stereoscopic display using locally stored crosstalk profiles, comprising:
generating a crosstalk profile for a stereoscopic display, wherein the crosstalk profile includes information for reducing crosstalk in the stereoscopic display based at least in part upon operational characteristics of the stereoscopic display;
storing the crosstalk profile in a memory locally associated with the stereoscopic display; and
applying, using a processor, the information in the crosstalk profile to stereoscopic content displayed on the stereoscopic display in order to reduce crosstalk in the displayed stereoscopic content.

2. The method of claim 1, wherein the storing step includes storing the crosstalk profile in an Extended Display Identification Data structure for the stereoscopic display.

3. The method of claim 1, wherein the storing step includes storing the crosstalk profile in a Display ID structure for the stereoscopic display.

4. The method of claim 1, wherein the generating step comprises generating the crosstalk profile based upon a size of the stereoscopic display.

5. The method of claim 1, wherein the generating step comprises generating the crosstalk profile based upon a type of 3D content to be displayed on the stereoscopic display.

6. The method of claim 1, wherein the generating step comprises storing within the crosstalk profile an optimal viewing distance for the stereoscopic display.

7. The method of claim 1, wherein:
the generating step comprises generating a plurality of different crosstalk profiles for the stereoscopic display; and
the applying step comprises selecting one of the plurality of different crosstalk profiles based upon a type of 3D content to be displayed and applying the information in the selected crosstalk profile to the displayed content.

8. The method of claim 1, wherein the applying step comprises using the information in the crosstalk profile to change pixel luminance values for the displayed stereoscopic content to compensate for the crosstalk.

9. The method of claim 1, wherein the generating step comprises applying a test mode to the stereoscopic display, wherein the test mode provides an indication of the crosstalk based upon the operational characteristics of the stereoscopic display.

10. A system for reducing crosstalk for a stereoscopic display using locally stored crosstalk profiles, comprising:
a stereoscopic display; and
a processor electronically connected to the stereoscopic display, wherein the processor is configured to:
generate a crosstalk profile for the stereoscopic display, wherein the crosstalk profile includes information for reducing crosstalk in the stereoscopic display based at least in part upon operational characteristics of the stereoscopic display;
store the crosstalk profile in a memory locally associated with the stereoscopic display; and
apply the information in the crosstalk profile to stereoscopic content displayed on the stereoscopic display in order to reduce crosstalk in the displayed stereoscopic content.

11. The system of claim 10, wherein the processor is configured to store the crosstalk profile in an Extended Display Identification Data structure for the stereoscopic display.

12. The system of claim 10, wherein the processor is configured to store the crosstalk profile in a Display ID structure for the stereoscopic display.

13. The system of claim 10, wherein the processor is configured to generate the crosstalk profile based upon a size of the stereoscopic display.

14. The system of claim 10, wherein the processor is configured to generate the crosstalk profile based upon a type of 3D content to be displayed on the stereoscopic display.

15. The system of claim 10, wherein the processor is configured to store within the crosstalk profile an optimal viewing distance for the stereoscopic display.

16. The system of claim 10, wherein the processor is configured to:
generate a plurality of different crosstalk profiles for the stereoscopic display; and
select one of the plurality of different crosstalk profiles based upon a type of 3D content to be displayed and apply the information in the selected crosstalk profile to the displayed content.

17. The system of claim 10, wherein the processor is configured to use the information in the crosstalk profile to change pixel luminance values for the displayed stereoscopic content to compensate for the crosstalk.

18. The system of claim 10, wherein the processor is configured to apply a test mode to the stereoscopic display, wherein the test mode provides an indication of the crosstalk based upon the operational characteristics of the stereoscopic display.
